(19) United States
(12) Patent Application Publication
(10) Pub. No.: US 2016/0081282 A1
(43) Pub. Date: Mar. 24, 2016

(54) ROOFING

(71) Applicant: SUNBOOST LTD., Ashkelon (IL)

(72) Inventor: Yair Salomon, Jerusalem (IL)

(73) Assignee: SUNBOOST LTD, Ashkelon (IL)

(21) Appl. No.: 14/888,925

(22) PCT Filed: May 27, 2014
(86) PCT No.: PCT/IL14/00029

§ 371 Date: Nov. 3, 2015

Related U.S. Application Data
(60) Provisional application No. 61/836,691, filed on Jun. 19, 2013.

(51) Int. Cl. A01G 9/24; A01G 9/14; H02S 40/44; G02B 27/10; G02B 27/12; H02S 40/22; E04B 7/18; G02B 19/00

(52) U.S. Cl. CPC A01G 9/243; E04B 7/18; A01G 9/1438; G02B 19/0042; G02B 27/10; G02B 27/126; H02S 40/22; H02S 40/44

(57) ABSTRACT

The construction roofing design includes one or more substantially static solar light PV collectors and one or more substantially static solar light directing devices. The substantially static PV collector and the substantially static solar light directing devices are facing each other at nominal angle smaller than 160° and larger than 110° . The substantially static solar light directing devices are configured to directs all or a part of the light impinging thereon towards the substantially static solar light PV collectors.

### TECHNOLOGY FIELD

The present roofing relates to construction roofing and in particular to agricultural constructions roofing.

### BACKGROUND

In the northern (southern) hemisphere south (north) facing roofs are used for solar energy harvesting only in a very limited way. In some buildings and constructions the amount of available solar energy is constrained and the amount of solar energy that can be allocated to different uses varies seasonally.

Agriculture uses different constructions. Such constructions could be farms for growing cattle, hen-houses, greenhouses and other constructions. Each of these constructions depending on its geographical location has different lighting and heat delivery and evacuation requirements.

Greenhouses, for example, are used to protect crops from the changes in environmental conditions such as direct sun, wind, heavy rains or hail, sand storms, frost, sudden cold, insects, and from other conditions. Greenhouses support accelerated growth and shorten crop harvesting cycles by providing improved crop growth conditions e.g. by heating the interior or in some installations by artificially increasing lighting hours using supplementary lighting systems. Greenhouses allow tighter crop management, extend growth seasons and improve crop quality and uniformity. Greenhouses come in many varieties; from basic net cover constructions that may serve to protect from frost or hail to advanced hydroponic growth glasshouses that control most of the environmental parameters.

Different greenhouse construction designs are used in different geographies and different climates. In some cases the greenhouses are opened, covered or whitewashed seasonally to control temperatures and to control the character and amount of solar light (diffused or direct) reaching the greenhouse interior space. Diffused light has been shown to be beneficial for many types of crops. Controlling the amount of light may also be performed to reduce the accumulation of heat in the greenhouse. In some cases, for example, in colder or less sunny seasons or climates, attempts have been made to maximize lighting to accelerate plant growth.

Sonneveldet al (“Static Linear Fresnel Lenses as LCPV System in a Greenhouse”, P. J. Sonneveld, G. L. A. M. Swinkels, B. A. J. van Tuijl, H. J. J. Janssen and H. F. de Zwart, CPV7 International Conference on Concentrating Photovoltaic Systems, Las Vegas, 4-6 Apr. 2011) have proposed combining solar energy harvesting (thermal and photovoltaic) by incorporating Fresnel lens in south facing greenhouse roofs, focusing light onto a combined Photo Voltaic (PV) and heating collector. The collector is tracking focus position, which is changing as the sun position is changing. The focusing lens is reducing the amount of light directed to the plants in the greenhouse. This system may be fit for some tropical plants which need reduced lighting conditions.

US 2011/0174294 A1 to Ader and Klier discloses a system that facilitates dynamically allocating a variable amount of solar radiation to or between multiple solar applications based on optimizing a time-dependent cost function using multiple parameters as inputs to the cost function. Also described is an optical architecture that enables dynamically channeling incident solar radiation to or between multiple solar applications based on the optimization of a cost function. A solar allocation and distribution system includes an allocation sub-system; a distribution sub-system; and a controller configured for controlling the allocation sub-system and the distribution sub-system based on optimizing a cost function, wherein the cost function is time-dependent and based on energy utilization of a facility

### SUMMARY

The present construction roofing design includes one or more substantially static solar light PV collectors and one or more substantially static solar light directing devices. The substantially static PV collector and the substantially static solar light directing devices are facing each other at nominal angle smaller than 160° and larger than 110°. The substantially static solar light directing devices are configured to direct all or a part of the light impinging thereon towards the substantially static solar light PV collectors. The solar light directing devices direct the light impinging thereon at different angles and the directing efficiency of directing solar light towards its recipients depends on the relative angle of the solar light that was directed.

The construction could be a construction for agricultural use and the roofing could be a roofing of a greenhouse, or a barn or a stable. The roofing could for example, be a greenhouse roof, and include at least one substantially static light directing device, and could be configured to direct solar light towards at least one substantially static PV collector predominantly in seasons with abundance of solar light. The roofing could for example, include a heating collector positioned underneath the substantially static solar light directing device and coupled thereto. The at least one substantially static solar light directing device could be configured to direct the solar light towards the heating collector and/or to direct the solar light towards at least one substantially static solar light PV collector in seasons with abundance of solar light.

A number of substantially static solar light PV collectors and a number of substantially static solar light directing devices could be arranged in rows and their electric output or generated heat could be added, accumulated, stored and used at other times as it could be required or desired.

The substantially static solar light directing devices include at least one plate made of substantially transparent material. A surface of the plate bears a pattern which could be an array of prisms. The prisms could be substantially linear prisms. The pattern could be coated by a coating that would filter the desired solar light wavelengths. A coating that, additionally or alternatively, improves surface mechanical performance and/or smoothness and/or cleaning properties and/or resistance to the accumulation of dirt could be used.

The roofing of the construction, although substantially static could have different orientations. The orientation of the roofing and the angles between the substantially static solar light PV collectors and static solar light directing devices depend for example on the climate, latitude and/or architectural constraints.

In general, it is desirable to have a substantially static system, in particular for roofing.

### BRIEF LIST OF FIGURES

FIG. 1 is a schematic illustration of a solar light and energy system according to an example;

FIG. 2 is a schematic illustration of an arrangement of one or more solar light PV collectors and one or more solar light directing devices;

FIG. 3 is a schematic cross section of an east-west configuration according to an example;

FIG. 4 is a schematic illustration of a construction suitable for installation at high latitude according to an example; and

FIG. 5 illustrates an example of a solar light directing device structure.

### DETAILED DESCRIPTION

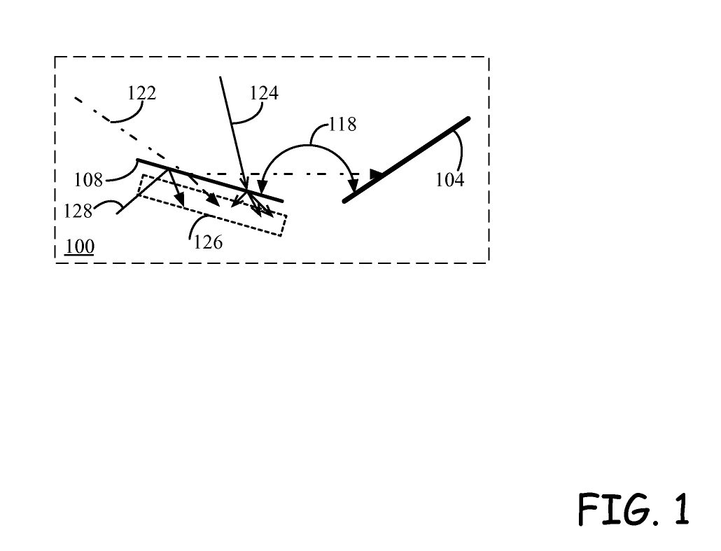

FIG. 1 schematically illustrates a solar system 100 including at least one solar light PV collector 104, and at least one selective solar light directing device 108. Both the solar light PV collector 104 and the selective 108 are substantially static devices that could be positioned at a predetermined angle and solar light directing device 108 is configured to direct the solar light impinging thereon at a plurality of angles onto solar light PV collector 104 and towards the a space underneath the solar light directing device with different efficiency. Solar light directing device 108 directs the solar light onto solar light PV collector 104 according to a first angle dependent directing efficiency and towards the a space underneath the light directing device according to a second angle dependent directing efficiency. Schematically, the function of the light directing device 108 is illustrated by light ray 122, which represents a light ray that is directed towards the solar light PV collector 104 according to the first angle dependent directing efficiency in an angular range wherein most of the solar light is directed at the solar light PV collector 104 and some part of the light is directed at the space underneath the solar light directing device, wherein the space is represented by dashed box 126, and light ray 124 represents a light ray according to the second angle dependent directing efficiency in an angular range where most of the solar light is directed at the space underneath the solar light directing device. Light ray 128 represents an optionally additional function of solar light directing device 108 that in some examples is configured to receive and direct solar light impinging thereon from the bottom side on the bottom surface, back towards the space underneath the light directing device according to a certain incidence angle dependent directing efficiency. Thus, a solar light directing device is configured to receive and direct solar light from top and bottom surfaces of the substantially static solar light directing device has a first angle dependent directing efficiency and second angle dependent directing efficiency that may be characterized for solar light impinging on the light directing device from either top or bottom directions (surfaces). Such configuration are of interest as in some cases sunlight could directly impinge on either top or bottom surfaces of said solar light directing device. The space underneath solar light directing device 108 could comprise a target or recipient of the solar light selected from a plurality of targets or recipients, for example: (i) an absorber located underneath the roofing and converting solar light or energy to heat, (ii) a space requiring lighting (illumination), (iii) a second type of solar light PV collector, or (iv) a combination thereof

Typically, the substantially static PV collector 104 and the substantially static solar light directing device 108 are facing each other at nominal angle 118 larger than 110° and even larger than 115°. In some examples the angle 118 could be larger than 120° or 125° and generally, angle 118 would not exceed 160°. In some examples, angle 118 would not exceed 155° or 150°.

In some examples system 100 is located as a roof of a construction. In case the construction already has a roof, system 100 could be installed on top of such roof. The construction could be a greenhouse or a building. It could for example, be desirable to include in a greenhouse construction a solar light and energy directing device or system that would support control of the amount of light delivered for plant growth and amount of light or energy delivered for solar energy harvesting. The solar light and energy directing device or system could be configured to direct solar light, when it is required, to enhance plant growth; for example, in course of mornings, evenings, or colder or less sunny seasons.

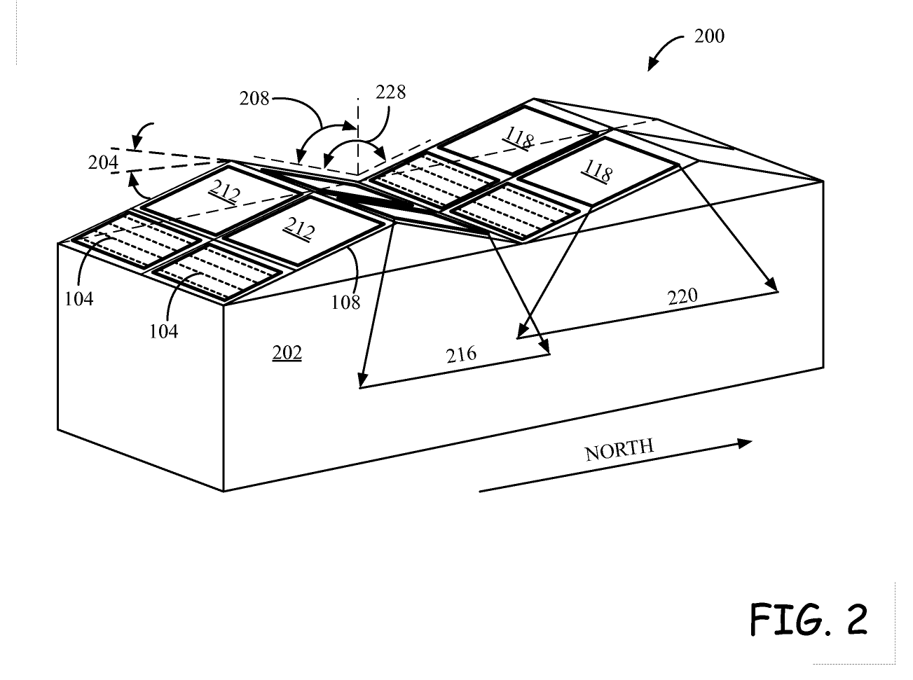

FIG. 2 schematically illustrates an arrangement of one or more solar light PV collectors 104 and one or more solar light directing devices 108. Both the solar light PV collectors 104 and solar light directing devices 108 are installed as part of a roof of a construction 200. The construction could be a greenhouse. The solar light directing devices 108 are configured so that the first angle dependent directing efficiency is substantially zero in a predetermined angular range, schematically designated in the figure by angle 204, preventing at least some of the direct solar light from impinging on solar light PV collectors 104 when the sun angular position is within the first pre-determined angular range 204 and is further configured to direct a substantial part of the solar light onto solar light PV collectors when the sun angular position is within the second angular range schematically designated by 208.

In some examples, the arrangement of one or more solar light PV collectors 104 and one or more solar light directing devices 108 could include one or more apertures 212 through which some of the solar light, including solar light prevented from impinging on solar light PV collectors 104, is directed onto a first pre-determined solar light recipient region 220. In some examples, light impinging on the back of the solar light directing device is predominantly directed into the interior of the greenhouse.

Affecting the amount of light directed to the interior of a greenhouse and its characteristics could be of help in improving the crop growth conditions, increasing the crop yields and, for example, in facilitating delivery of the crops to market at a competitively earlier time. In addition it could beneficial to produce some auxiliary solar energy products, for example, heat and electricity or cooling which could be used directly in the greenhouse, or as separate products. Such constructions are further enhancing utilization of solar light.

In one example, potentially in addition to the directing of light through the apertures 212, diffused and/or refracted light is directed into greenhouse 200 interior 202 though the solar light directing devices 108; this is schematically illustrated in FIG. 2 wherein one or more solar light directing device 108 are at least partially transparent to additional light impinging thereon from a second pre-determined angle range 228, thereby facilitating directing the additional light onto a second pre-determined solar light recipient region 216. In some examples the first and the second solar light recipient regions, 216 and 220 respectively, could partially overlap or be similar.

In some examples an insect net could be set in apertures 212 to prevent insects from entering the interior space 202 of the construction, while allowing heat evacuation and air flow. Alternatively, glass, diffusive glass, transparent polymer sheets or diffusively transparent polymer sheets could be set in apertures 212 for example to additionally reduce heat escape from the interior space 202 of the construction and/or to improve light distribution 220.

As it is illustrated in FIG. 2 construction 200 roofing includes substantially static solar light PV collectors and substantially static solar light directing device arranged in rows.

In some examples similar to the examples illustrated in FIG. 2 the substantially static solar light PV collectors are placed on south (north) facing roof segments in the north (south) hemisphere. The solar light PV collectors could occupy less than 50% of the south facing roof segments, enabling a significant portion of the solar light impinging on the south facing roof segments be directed to complementary solar light recipients, which could include the space underneath the roofing. In one example, solar light PV collectors occupy less than 25% and sometimes less than 15% of the south facing roof segments supporting an increased amount of light impinging on the south facing roof segments to be directed at complementary solar light recipients.

The orientation of the at least one solar light directing device could be configured according to roof constraints and solar orbit or path. Such configuration could be characterized by the angles of incidence of solar light relative to the nominal normal of the light directing device and the statistics of the solar orientations and climate, e.g. the statistically annually averaged percentage of daytime in which the solar orientations and insolation satisfy certain geometrical and irradiation level criteria.

In some examples the light directing device could be generally facing away from the sun most of the daytime. In some examples, the percentage of daytime in which the angle between the nominal normal to the at least one substantially static solar light directing device and the solar position angle is larger than 60° is annually (i.e. as calculated over a year) higher than 50%, or even higher than 60%, and in some additional examples even higher than 70%.

In some examples the percentage of daytime in which the angle between the nominal normal to the at least one substantially static solar light directing device and the solar position angle is larger than 45 degrees is annually higher than 60%, or even higher than 70%, and sometimes even higher than 80%.

In some examples, the substantially static solar light PV collector and the substantially static solar light directing device are spaced apart and could form roofing of separate constructions such as separate farm constructions. In some examples, such farms constructions are spaced apart by a 5 to 20 meter distance. In some examples, a row of solar light directing devices could comprise double or multiple arrangements of solar light directing devices.

FIG. 2 illustrates an example where system 200 was located north of the northern latitude 30°. The substantially static solar light PV collectors could be arranged in rows at tilt 15°, oriented to generally face the south direction, and solar light directing devices reflecting and/or deflecting optical panels are reversely oriented to generally face north at a tilt angle higher than 25°, or even higher than 35°, and sometimes even higher than 50°, the solar light directing device highest point could be substantially higher than the highest point in the solar light PV collectors and wherein angle between the line defined by said points and the horizon is at least 30° and sometimes at least 40°. It should be noted that generally facing south or north or any direction means that the orientation facing this direction may be facing this direction within a tolerance of less than 30°, and even less than 10°.

In some examples, in equatorial or subtropical latitudes, where seasonal variation of the solar day time could be small, it could be desirable to affect the amount of solar light entering a building or a greenhouse throughout the day and to use the surplus light energy by targeting it to additional recipients during extended seasons and even throughout the whole year.

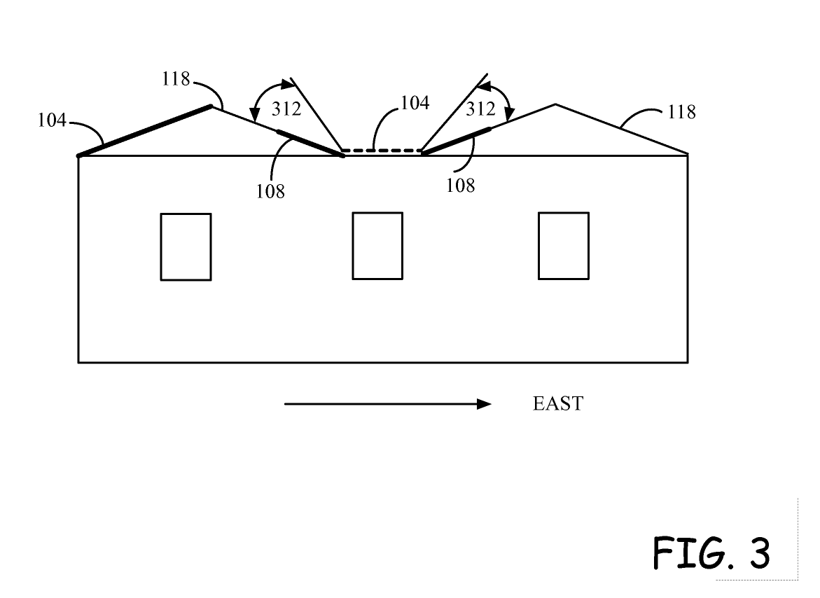

FIG. 3 is a schematic cross section of an east-west configuration according to an example, wherein the roofing is generally facing east and west and either one or both of the at least one solar light PV collector and the at least one solar light directing device are generally facing east and west. The configuration is, without limitation, appropriate for use in equatorial or subtropical latitudes. In the illustrated example solar light PV collectors 104, solar light directing device 108 and apertures 118 are arranged symmetrically, first pre-determined angle range 312 comprises angular ranges wherein the solar light is significantly directed by the at least one solar light directing devices towards the at least one solar light PV collector 104. The configuration does not have to be symmetric as may be implied from the schema, and for example, the solar light PV collectors may be slightly tilted east or west to let rain water flow off their front surfaces, and angles 108 and angle ranges 312 may slightly differ between east and west tilted solar light directing devices.

According to an example the at least one solar light PV collector and the at least one solar light directing device are substantially static. According to an example, the at least one solar light PV collector and the at least one solar light directing device could be moved for maintenance, or change their tilt to periodically account for season change or to allow opening and closing apertures in the roofing, but generally both the solar light PV collector and the solar light directing device remain substantially static.

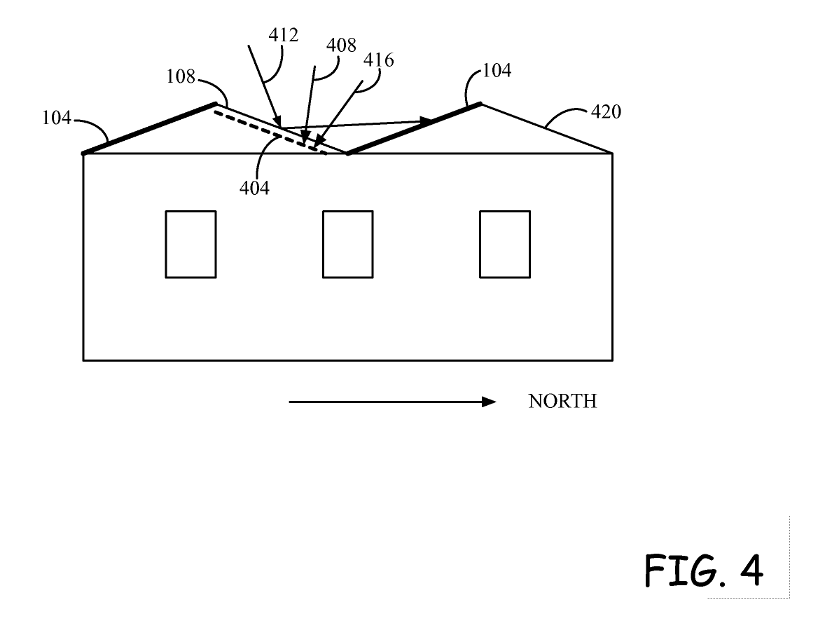

In reference to FIG. 4, a roof including at least one heating collector is disclosed and a schematic illustration of a construction suitable for installation at high latitude according to an example is provided. The installation could include one or more solar light directing devices 108 that could be positioned on top of a heating collector 404 and configured to partially direct incident solar light 408 towards the heating collector 404 and to direct another part of the incident solar light towards a solar light PV collector 104, mostly in seasons where there is excess solar light. The illustrated construction also includes roof segment 420 which could be a conventional roof, a glass roof or a roof segment comprising at least a solar light directing device for directing light to an additional separate solar light recipient.

Solar heating collectors convert solar radiation to heat, typically by heating a fluid medium (air, water, brine or oil) that may be used for residential or industrial use; e.g., heating water, space heating or industrial process heat, or cooling by absorption chilling.

Thermal power harvesting is in general more efficient then photovoltaic power harvesting; however, care must be taken to use generated heat effectively. High efficiency solar heating collectors have been recently promoted for heating applications in colder geographical regions; however, their use in warmer or sunnier climates or seasons is limited by the formation of excess heat which requires in some cases heat release to prevent damages to the collectors. It would be desirable to reduce the formation of excess heat, potentially by directing some of the solar light energy to a solar light PV collector or an alternative solar light recipient. It would be further desirable to provide a solar energy directing system that would support affecting the amount of light delivered for thermal power, e.g., directing more solar light energy for thermal power harvesting when the solar energy is in greater demand; for example, in mornings, evenings, and colder or less sunny seasons.

Referring back to FIG. 4, by using a high efficiency heating collector 404 sufficient heat collection could be performed in even relatively extreme conditions on a north facing segment of roof. Rays 408 and 412 represent solar light impinging on the solar light directing device 108 at relatively high sun elevations representative of direct solar light impinging on the solar light directing device in the warmer seasons. Ray 412 illustrates that in the warmer seasons some of the solar light is directed towards the solar light PV collectors 104 increasing solar light collection by the solar light PV collectors. Consequently, the variation of the amount of heat collected by the heating collector through different seasons is reduced and the potential excess load on the heating collector is also reduced. Ray 416 illustrates that some of the light could actually come from azimuths which are north to the east-west line and this light could be diffusive sky radiation or direct sun light. Here, ray 416 additionally illustrates the coupling of such light to the heating collector. In different examples the at least one solar light PV collectors and the at least one solar light directing device and the coupled to, at least one heating collectors cover different proportions of the roofs.

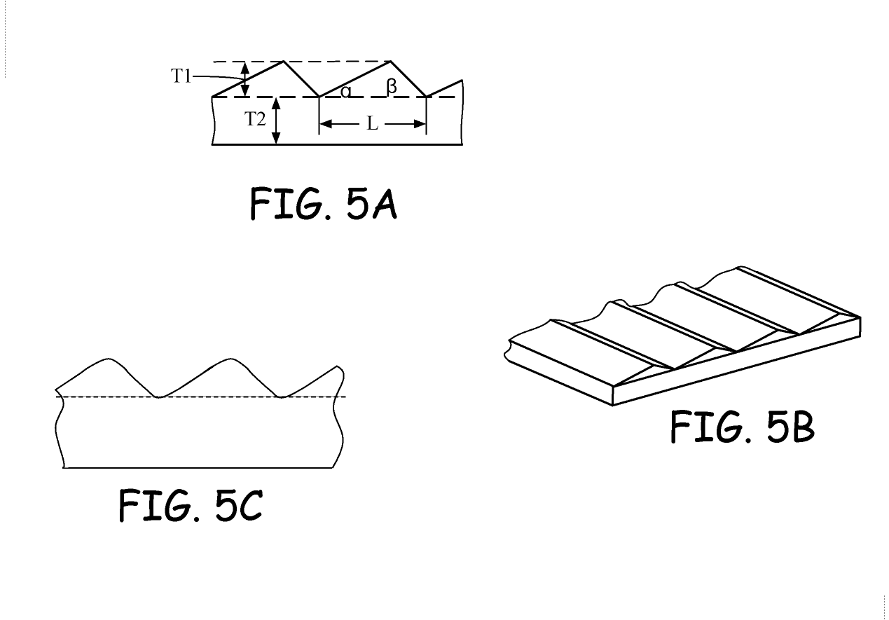

FIG. 5 is a schematic illustration of a substantially static solar light directing device structure according to an example. FIG. 5A provides a right side view (not to scale) of a section of the substantially static solar light directing device, and FIG. 5B provides an isometric (not to scale) view of a section the substantially static solar light directing device. The substantially static solar light directing device includes a substrate with a patterned surface. The patterned surface could be an array of prisms and wherein the prisms are substantially linear prisms, i.e. arranged in lines. The prisms could be imperfect and could have for example, rounded edges. Prisms with some rounding of their edges could be referred to as rounded prisms. Prism lines correspond to the vertices of sections through the prism patterns or to the extreme points (highest and lowest) of such sections in the case of imperfect prism. Prism lines could be nominally parallel or rotated relative to edges, frame or outlines of the solar light directing device (rotation around the nominal normal is also termed ‘yaw’) and could, additionally, periodically vary in their position relative to the edges of the solar light directing device, e.g. by a periodic function such as a cosine. Variation of the prism lines positions and rotations could be a composite variation. The patterned surface could comprise more than one type or size of prism patterns and could for example vary continuously, stepwise, periodically, pseudo-randomly, or by a combination thereof. Prism patterns characteristics could be controllably varied along prism lines or in between consecutive prism lines. Prism patterns surfaces, either top or bottom surfaces, could be smooth or controlled to form matt or diffusive texturing.

The substrate with a patterned surface could be made of glass or a polymeric material, e.g. acryl or polycarbonate, and the patterned substrate could include a prismatic structure on its top surface and a substantially flat bottom surface. The thickness of the substrate could vary for example due to manufacturing limitations, and may consequently comprise certain waviness in the flatness of its bottom surface. In one example, the substantially static solar light directing device is a rectangle with length and width similar to the length and width of conventional solar light PV collectors. The substantially static solar light directing device could be framed or could be frameless.

In some examples, the patterned substrate of the substantially static solar light directing device could include elements configured to reflect and/or deflect and/or spectrally select or filter certain wavelength of the incident solar light.

Referring to FIG. 5A, T1 denotes Prism depth, T2 denotes the substrate thickness, and prism angles respectively denoted by Greek letters alpha and beta. In a particular example T1 is larger than 0.1 mm; in another example, T1 is larger than 0.5 mm. In a further example T1 is smaller than 1.0 mm. In an example T2 is approximately equal to 2×T1, although according to some examples T2 could be 2×T1<T2<5×T1. In an example, angle alpha (a) could be larger than 20° but smaller than 40°, and angle beta (β) could be larger than 30° and smaller than 50° . In a preferred embodiment 25°<alpha<35°, and 35°<beta<47°. In a further example, angle alpha could be larger than 27° but smaller than 32°, and angle beta could be larger than 40° and smaller than 45°. Other alpha and beta prism angles could depend on the latitude of the installation, roof tilt and other constraints. In some examples, prism lines could be slightly tilted or have a variation (e.g. sinusoidal variation) with respect to the nominal length and width of the substantially static solar light directing device. In some examples the radius of the rounding of edges could be between 0.05 mm and 0.15 mm. In some examples the radius of the rounding of edges could be between 0.15 mm and 0.35 mm.

The substantially static solar light directing device could be coated by a coating tailoring its reflective characteristics and/or to facilitate self-cleaning or dust repelling properties. In some examples a coating is used or an additive is added into the substrate material to absorb or reflect certain portions of the solar spectrum. In particular examples UV and/or light wavelengths corresponding to green are blocked from penetrating the substrate or from passing through.

The substantially static solar light PV collectors could optionally include coupled elements supporting certain additional functionality. For example, for heat exchanging, piping containing a heat transfer fluid could be coupled to the PV collector back surface. Such solar light PV collectors support the reduction the their temperature during operation which is increases due to the additional light directed thereto by the solar light directing device and of heating of the volume under the construction integrated structure because, intrinsically , a first significant portion of the light is converted into electricity and, extrinsically, a second portion that is converted into heat is evacuated by the heat exchangers or by transferring the heat into the ambient through collectors' surfaces. Such constructions are enhancing utilization of solar light. Heat exchanging could include PV cooling through a ground loop or by air or fogged air. In an embodiment ground loop is used to store evacuated heat in the ground (a heat reservoir), which is serving as a buffer and storage. In an embodiment said PV connected heat exchangers are configured to control the temperature in a construction, which could be a residential or industrial building or greenhouse.

In an example heat could be pumped through such piping during the night from a reservoir to the solar light PV collectors heating them up and enabling the evacuation of accumulated heat from the substantially static solar light PV collector surface of the system by radiation and by convection.

1. A roofing for a construction, said roofing comprising an arrangement of:
at least one substantially static solar light PV collector and at least one substantially static solar light directing device; and
wherein the at least one substantially static PV collector and the at least one substantially static solar light directing device are facing each other at nominal angle smaller than 160° and larger than 110°; and
wherein the at least one substantially static solar light directing device directs at least part of the light impinging thereon in different angles towards the at least one substantially static PV collector according to a first angle dependent directing efficiency, and part of the light towards a space underneath said roofing according to a second angle dependent direction efficiency; and
wherein the arrangement includes one or more apertures (212) through which some of the solar light, including solar light prevented from impinging on solar light PV collection (104), is directed onto a first pre-determined solar light recipient region 220.

2. The roofing according to claim 1 wherein the construction is a greenhouse and the roofing is a roofing of a greenhouse.

3. The roofing according to claim 1, wherein the at least one substantially static light directing device is configured to direct solar light towards the at least one substantially static PV collector predominantly in seasons with abundance of solar light.

4. The roofing according to claim 1 further comprising at least one heating collector positioned in the space underneath the substantially static solar light directing device and coupled thereto.

5. The roofing according to claim 4 wherein in seasons with abundance of solar light, the substantially static solar light directing device is configured to direct the solar light towards the heating collector and to direct the solar light towards at least one substantially static solar light PV collector.

6. The roofing according to claim 1 wherein at least one solar light PV collector and at least one substantially static solar light directing device are arranged in rows.

7. The roofing according to claim 1, wherein at least one substantially static solar light directing device comprises at least one plate made of substantially transparent material and having at least one patterned surface.

8. The roofing according to claim 7, wherein at least one substantially static solar light directing device is configured to receive and direct solar light from top and bottom surfaces of the substantially static solar light directing device.

9. The roofing according to claim 7 wherein the patterned surface comprises an array of prisms or rounded prisms.

10. The roofing according to claim 1, wherein said at least one substantially static solar light directing device partially filters the light impinging on it.

12. The roofing according to claim 1 wherein percentage of daytime in which the angle between the nominal normal to the at least one substantially static solar light directing device and solar position angle is larger than 60° is annually higher than 50%.

13. The roofing according to claim 1 wherein percentage of daytime in which the angle between the nominal normal to the at least one substantially static solar light directing device and solar position angle is larger than 45 degrees is annually higher than 60%.

14. A method for enhancing utilization of solar light, said method comprising:
providing a roofing for a construction, said roofing including an arrangement of:
at least one substantially static solar light PV collector and at least one substantially static solar light directing device facing each other at nominal angle larger than 110°;
using at least one substantially static solar light directing device to direct at least part of the light impinging thereon towards the at least one substantially static PV collector according to a first angle dependent directing efficiency, and part of the light towards a space underneath said roofing according to a second angle directing efficiency; and
using one or more apertures 212 through which some of the solar light including solar light prevented from impinging in on solar light PV collectors 104, is directed onto a first pre-determined solar light recipient region 220.

15. The method according to claim 14 wherein the construction is a greenhouse and the roofing is a roofing of a greenhouse.

16. The method according to claim 14 further comprising providing at least one heating collector positioned underneath the substantially static solar light directing device and coupled thereto.
